(19) United States
(12) Patent Application Publication
(10) Pub. No.: US 2005/0247676 A1
(43) Pub. Date: Nov. 10, 2005

(54) Circuit breaker

(76) Inventors: Duncan John Telfer, Southport (GB); Gordon Rees Jones, Wirral (GB); James Edward Humphries, Liverpool (GB); Joseph William Spencer, Liverpool (GB)

Correspondence Address: MOSER, PATTERSON & SHERIDAN, L.L.P., 3040 POST OAK BOULEVARD, SUITE 1500, HOUSTON, TX, 77056, US

(21) Appl. No.: 11/119,051

(22) Filed: Apr. 28, 2005

Related U.S. Application Data
(63) Continuation of application No. PCT/GB03/04617, filed on Oct. 28, 2003.

(30) Foreign Application Priority Data
Oct. 29, 2002 (GB) GB 0225088.4

(51) Int. Cl. H01H 33/88

(52) U.S. Cl. 218/62

(57) ABSTRACT

A circuit breaker is disclosed which has first and second electrodes that can be contacted to complete a circuit or withdrawn from each other by some suitable mechanism to break the circuit. During breaking of the circuit, an electric arc is created. The circuit breaker includes means for providing gas pressure below atmosphere around the electrodes, at least at the time the arc is struck. The circuit breaker also includes a shield arranged in proximity to the electrodes which is ablated by the action of the arc. The shield's arrangement and material are chosen such that, when ablated, the shield releases gas to assist in extinguishing the arc.

### CROSS-REFERENCE TO RELATED APPLICATIONS

This application is a continuation of co-pending PCT patent application No. PCT/GB2003/004617, filed 28 Oct. 2003, which claims the benefit of GB patent application serial number 0225088.4, filed 29 Oct. 2002. Each of the aforementioned related patent applications is herein incorporated by reference in their entireties.

### BACKGROUND OF THE INVENTION

1. Field of the Invention

The invention generally relates to circuit breakers.

2. Description of the Related Art

Circuit breakers typically utilize a pair of electrical contacts, maintained normally in contact with each other, through which an electrical contact is made. To break the circuit, e.g., upon detection of a fault condition, one contact is moved relative to the other to separate the two contacts. As the contacts are moved apart, due to the potential gradient between them, an electrical arc is created. Where high voltages are involved, it is necessary to arrange for this arc to be extinguished to prevent excessive damage to the circuit breaker and other attendant hazards.

It is well known, in order to extinguish the arc, to place the contacts in a sealed vessel filled with a background gas consisting of sulphur hexafluoride (SF₆) at high pressure (typically in the region of 600 kPa (six atmospheres)). The gas is chosen for its dielectric properties, enhanced by its pressurization, by virtue of which arcing is reduced. Such circuit breakers are in use in, for example, the substations and switching stations used in commercial electricity supply networks.

In some examples, the effect of the gas is further enhanced by arranging, through a “puffer” arrangement of a piston coupled to the circuit breaker's movable electrode, that as the electrodes are separated a flow of gas passes over them. U.S. Pat. No. 4,339,641 (General Electric Corporation) discloses such an arrangement.

The same document illustrates the provision of a shield or nozzle around the electrodes, formed of dielectric material, by means of which the arc is to some degree confined. The design of this component is intended among other objects to maximize gas pressure for arc extraction and minimize ablation of the nozzle material.

Sulphur hexafluoride is recognized as a highly potent greenhouse gas (several orders of magnitude more potent than carbon dioxide), and there are consequently both official recommendations and important commercial incentives to dispense with it. One approach which is the subject of currently active research is to seek a substitute dielectric gas. Such research has been based on the use of elevated pressure, as in the known circuit breakers using sulphur hexafluoride. An option known in the literature is to use a proportion of sulphur hexafluoride in combination with some other less harmful gas, but clearly the goal of dispensing with SF₆ is not thereby achieved.

High voltage circuit breakers are known which do not utilize a dielectric gas for arc extinction but instead have electrodes in an evacuated housing. However in such devices, the electrical arc typically generates temperatures sufficient to cause an undesirable degree of ablation of the electrodes themselves, reducing the electrode's working lifetime.

An example of a circuit breaker which operates at low pressure is provided by UK patent application 2087651 (Westinghouse Electric Corporation et al.). It appears that this is a device having low current density at the contacts, and the low gas pressure serves “to minimize contact erosion”. Annular shields around the perimeters of the contacts serve to intercept hot, eroded material.

### SUMMARY OF THE INVENTION

In accordance with a first aspect of the present invention, a circuit breaker comprises first and second electrodes which are contactable with each other to complete an electric circuit, a withdrawal mechanism for moving one electrode away from the other to break the circuit, means for providing, at least in the vicinity of the electrodes and at the instant of striking of an arc between them during breaking of the circuit, a gas pressure below atmospheric pressure, and a shield arranged in proximity to the electrodes such as to be subject to ablation by the aforementioned arc, the material and arrangement of the shield being such that ablation of the shield by the arc causes the shield to release arc-extinguishing gas.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified section view, in an axial plane, through a circuit breaker according to one embodiment of the present invention;

FIG. 2 is a simplified section view, in a radial plane, through the same embodiment of FIG. 1;

FIG. 3 is a graph of experimental data showing the critical electrode gap (vertical axis) against gas pressure (horizontal axis) for several different background gases used in a circuit breaker;

FIG. 4 is a graph of experimental data showing critical electrode gap (vertical axis) against peak alternating current (horizontal axis) in a circuit breaker according to one embodiment of the present invention and using several different background gases; and

FIG. 5 is a graph of experimental data showing the magnitudes of extinction and re-ignition voltage peaks for different gases, for a gas pressure of 25 kPa (3.7 psi) and peak alternating currents of 20 kA.

### DETAILED DESCRIPTION OF THE PREFERRED EMBODIMENT

Overview

In accordance with a first aspect of the present invention, a circuit breaker comprises first and second electrodes which are contactable with each other to complete an electric circuit, a withdrawal mechanism for moving one electrode away from the other to break the circuit, means for providing, at least in the vicinity of the electrodes and at the instant of striking of an arc between them during breaking of the circuit, a gas pressure below atmospheric pressure, and a shield arranged in proximity to the electrodes such as to be subject to ablation by the aforementioned arc, the material and arrangement of the shield being such that ablation of the shield by the arc causes the shield to release arc-extinguishing gas.

In experiments, the inventors have unexpectedly observed that arc extinction can be enhanced when the pressure of background gas is reduced below atmospheric pressure, which in this context is 101325 Pa. It is found by experiment that an effective circuit breaker can be constructed in accordance with aspects of the present invention despite, and in fact by virtue of, the low gas pressure utilized. This is contrary to expectation.

In one embodiment, the shield may form a cavity within which arcing takes place. In this way, the desired ablation and also the arc extinguishing effect of the gas can be increased. Pressure within the cavity may be transiently increased by the effects of the arc, further improving arc extinction. The shield may comprise electrically insulating material.

The electrodes and the shield may be contained in an enclosure which further contains a background gas. Sub-atmospheric pressure in the vicinity of the electrodes may thus be provided by providing a suitable gas pressure in the enclosure.

The background gas need not comprise a dielectric gas such as SF₆. Currently, the favored gas is nitrogen. Alternatively, other gas or gases such as Argon, carbon dioxide and air may be utilized.

In one embodiment, the background gas pressure inside the enclosure is about 60 kPa or below. A pressure of about 34 kPa (about 5 psi) is believed to be even more favorable. It is currently believed that a pressure above 7 kPa (1 psi) is desirable although the effect of pressures below 7 kPa (1 psi) have to date not been thoroughly studied.

An alternative, or additional, means for providing the required pressure in the vicinity of the electrodes comprises means for withdrawing gas from this vicinity during the process of breaking the electrical circuit. Pressure is thus transiently reduced in this vicinity. A piston/cylinder arrangement may be utilized to withdraw the gas.

### DETAILED DESCRIPTION

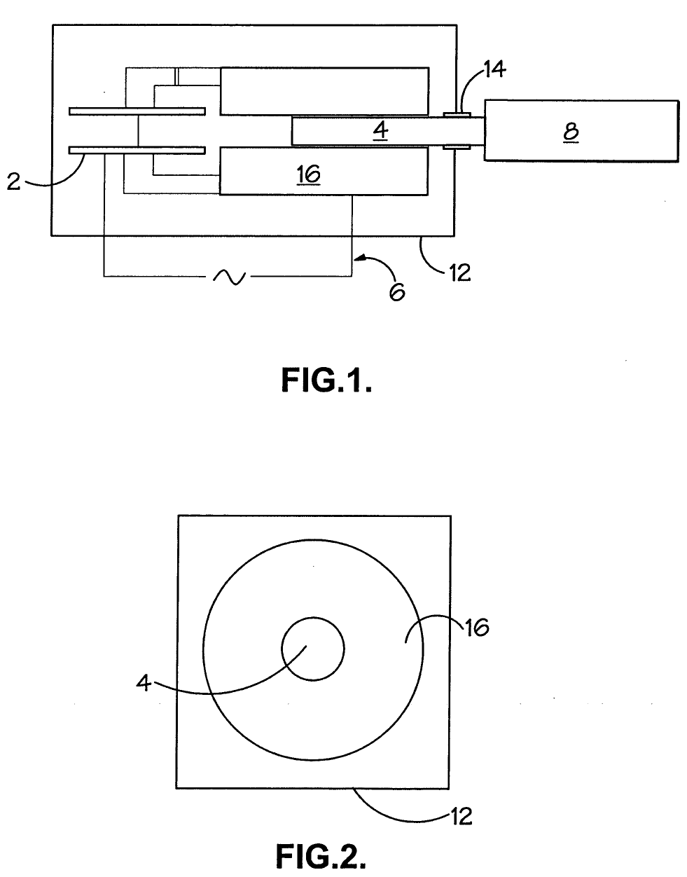

As illustrated in FIGS. 1 and 2, a circuit breaker according to one embodiment of the present invention comprises a tubular static electrode 2 coaxially mounted with a cylindrical movable electrode 4. The movable electrode 4 is a sliding fit in the fixed electrode 2. FIG. 1 shows the movable electrode to be withdrawn from the fixed electrode, in order to break an associated electrical circuit indicated, purely schematically, at 6. However when (as under normal operating conditions) the circuit breaker is closed, the movable electrode 4 contacts the fixed electrode 2 to complete the circuit 6. More specifically, in the present embodiment, an end portion of the movable electrode 4 is received in and contacted by the fixed electrode 2.

The movable electrode 4 is coupled to a withdrawal mechanism 8 which is schematically indicated. Suitable mechanisms are well known in the art, their function being to rapidly withdraw the movable electrode 4 along the direction of the electrode axis, and will not be described in detail herein beyond noting that a standard type of hydraulic actuator may be used, and that pneumatic or solenoid actuated devices are possible alternatives.

The electrodes 2, 4 are contained in an enclosure 12, formed in the present embodiment as a metal tube. The enclosure 12 serves to maintain around the electrodes a background gas, introduced prior to use of the circuit breaker, whose nature and purpose will be considered below. The withdrawal mechanism 8 is in this embodiment disposed outside the enclosure 12, the movable electrode 4 emerging from the enclosure through a sealing gland 14 (whereby passage of gas in this region is prevented) to reach the withdrawal mechanism 8.

Also disposed within the enclosure 12, and in the vicinity of the electrodes 2, 4, is an insulating shield 16. In the present embodiment, the shield 16 is an annular body into whose interior the movable electrode 4 extends. When the contact breaker is closed, the movable electrode 4 projects out of the shield 16 to contact the static electrode 2.

While other materials may be used, one embodiment utilizes polymeric material for the insulating shield 16. One particularly suitable material is polytetrafluoroethylene (PTFE). The shield lies closely around one of the electrodes, in the present example the movable electrode 2, which it partly surrounds, and is of a type referred to as a “close proximity shield”.

The particular arrangement and configuration of the electrodes and shield is presented merely by way of example and may differ in other embodiments.

In one embodiment, the background gas is nitrogen (N₂) at a pressure of about 25 kPa (about 3.7 psi). It is found in experiment that the illustrated circuit breaker performs well despite its lack of a background gas (such as SF₆) with high dielectric properties and despite the fact that the gas is at low pressure. This is contrary to expectation. It is believed by the inventors that this good performance is due to the presence of both the shield and the sub-atmospheric pressure background gas. The inventors have found that, in the illustrated circuit breaker, ablation-promoted arc extinction is enhanced by reducing the background gas pressure below atmospheric pressure.

While the intention is not to limit the present invention by reference to any specific explanation of its performance, it is believed that the effect of the low background gas pressure is to cause the plasma arc produced upon breaking of the circuit to spread more widely, as compared with the arc created in a conventional high pressure device, and thereby to increase ablation of the shield 16. The shield comprises a material which ablates to gaseous form in the presence of an electrical arc. In the exemplary embodiment, the PTFE shield is capable of arc-induced ablation and produces, in response, fluorines and fluorides with excellent arc extinguishing properties. Chemical reactions produce gases including carbon tetrafluoride (CF₄) and C₂F₆. The process involves sublimation of the PTFE monomers and their dissociation, which processes are in themselves endothermic. Based on the current and duration of the arc and based on the mass ablated from the shield in experimental examples, the inventors have calculated that roughly 30% of the arc's energy may go into ablation of the shield material, assisting extinguishing of the arc. The ablated material also provides a “chemical puff” of arc-extinguishing gas. The resulting effect provides effective arc extinction without the need of SF₆ as a background gas. Following striking of the arc, pressure in the region of the electrodes is temporarily increased by the heat and the ablation products generated by the arc, and this increased pressure is also believed to assist arc extinction. Products of the ablation may be vented through the open ends of the shield 16.

Certain of the gases produced by the arc-induced shield ablation are in themselves environmentally undesirable, but it is believed that at least some of the chemical species produced by the arc ablation re-combine to leave materials that are environmentally non-threatening. That is, the chemical species required for arc extinction are, at least in part, only transiently produced. Following arc extinction and with appropriate delays caused by chemical recombination time scales, the chemically reactive fluorine/fluorides recombine to form solid fluorides which do not easily disperse to form an environmental threat as do halogenic gases.

To enhance dielectric recovery with gas pressure while respecting the need for sub-atmospheric gas pressure for ablation-induced arc extinction, the illustrated embodiment utilizes a “reverse puffer” principle. Piston action of the moving contact 4 within the shield 16 is utilized, upon withdrawal of the contact 4, to reduce the pressure within the cavity in the shield 16. This enables the ablation to be maximized for the thermal recovery (including ablation-enhanced pressurization) while subsequently providing sufficient gas pressure for good dielectric withstand.

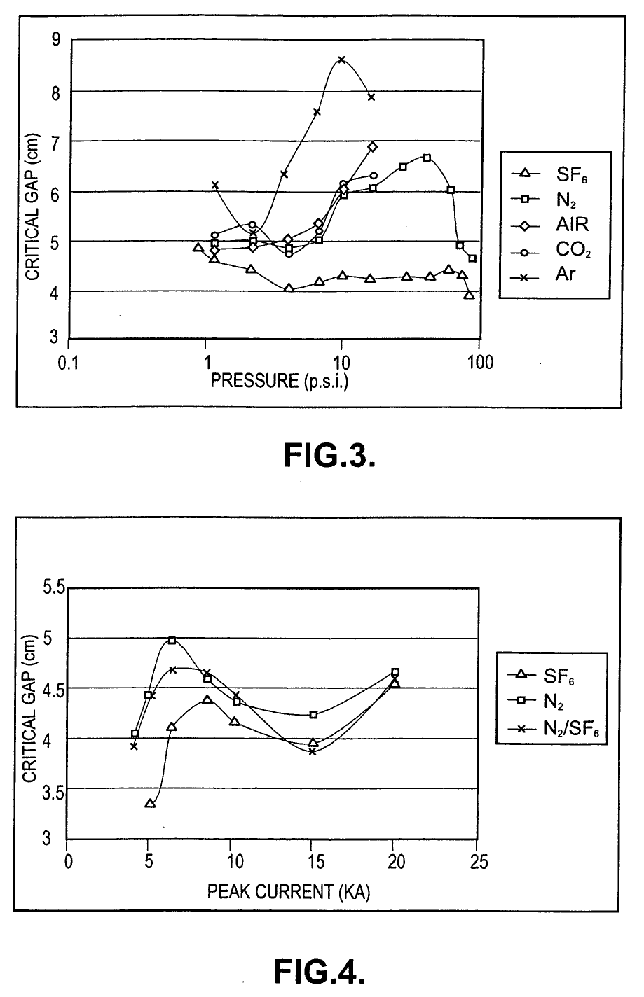

Test results are provided in support of the claim regarding the efficacy of sub-atmospheric pressure operation and of gases other than SF₆. FIG. 3 shows the shortest gap lengths between contacts required to interrupt an alternating fault current of peak value 20 kA for various gas pressures in the range of about 6 kPa to about 580 kPa (about 0.8 to about 84 psi), the horizontal scale being logarithmic. Results are provided for five different gases, including SF₆, N₂, air, CO₂ and Ar. Notable features are:
(a) relatively small dependence upon gas pressure with SF₆;
(b) improved interruption with N₂ for p<48 kPa (7 psi);
(c) similar performance of N₂ to SF₆ for p<48 kPa (7 psi);
(d) similar behavior of CO₂, air to N₂, SF6 for p<48 kPa (7 psi); and
(e) generally poorer performance of Ar but nonetheless showing a similar trend as N₂ and CO₂.

The similar performance of the gases tested below 48 kPa (7 psi) implies the dominance of a common feature believed to be ablation of the shield and pressurization due to arc heating of the products of ablation.

Weighing the PTFE shield used in the tests after some 250 test firings indicates on average a PTFE weight loss of 0.14 grams per firing (for cylinder and moving electrode diameter of 2.2 cm). The erosion of the PTFE wall was significant but not excessive, and performance deteriorated only slightly over 250 tests at fault currents of 20 KA max.

FIG. 4 shows the results of experiments to examine the effect of peak alternating current on the critical gap length for current interruption at a pressure of 3.7 psi. These show a trend for the interruption performance at lower currents to be approximately as effective as at 20 KA, as judged by the critical gap length criterion.

Tests have also been conducted on an 80:20 N₂:SF₆ mixture, which behaves in a similar manner to pure SF₆ and N₂. At the present state of knowledge, there therefore appears to be no significant advantage in utilizing N₂:SF₆ mixtures in preference to pure N₂ unless the recovery of dielectric strength might be improved.

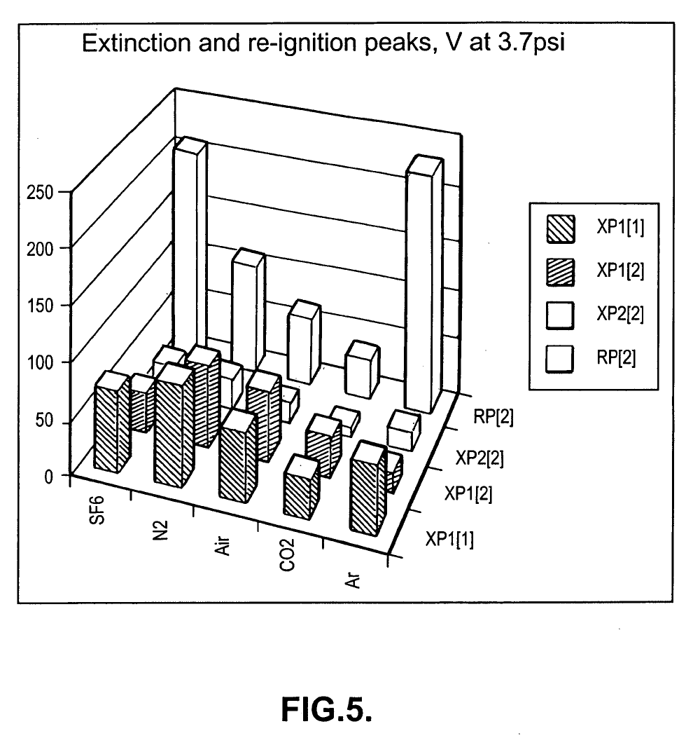

The critical gap length results of FIGS. 3 and 4 are supported by measurements of the magnitude of the voltage extinction peaks close to the critical gap length for current interruption for the various gases at 20 kA peak current and a pressure of 25 kPa (3.7 psi), as shown in FIG. 5. In this diagram, the labels on the Z axis are as follows:
XP1=first half-cycle extinction peak;
XP2=second half-cycle extinction peak;
RP=second half-cycle re-ignition peak;
and the parenthesised labels:
[1] denotes 1× half cycle critical firing; and
[2] denotes 2× half cycle pre-critical firing.

It should be noted that the requirement for sub-atmospheric pressure gas in the vicinity of the electrode and shield upon striking of the electrical arc may be met, e.g., by virtue of the illustrated “reverse puffer” arrangement, without the ambient pressure of background gas in the enclosure 12 being below atmospheric. Thus, the background gas pressure may be atmospheric (or conceivably even higher) with the required sub-atmospheric pressure around the electrodes being transiently created when the circuit breaker is activated to break the circuit.

Furthermore, the pressure in this vicinity is, as has been noted above, increased by the action of the electrical arc and is transiently increased following striking of the arc.

While the foregoing is directed to embodiments of the present invention, other and further embodiments of the invention may be devised without departing from the basic scope thereof, and the scope thereof is determined by the claims that follow.

1. A circuit breaker, comprising:
a first electrode and a second electrode which are selectively contactable with each other to complete an electric circuit;
a withdrawal mechanism for moving one electrode away from the other to break the circuit;
a gas source for providing a gas pressure below atmospheric pressure and at least in a vicinity of the electrodes at an instant of striking of an arc between the electrodes during breaking of the circuit; and
a shield arranged in proximity to the electrodes such as to be subject to ablation by the arc, wherein the material and arrangement of the shield are such that ablation of the shield by the arc causes release of arc-extinguishing gas.

2. The circuit breaker of claim 1, wherein the shield defines a cavity within which arcing takes place.

3. The circuit breaker of claim 2, further comprising:
a gas evacuation provision for withdrawing gas from a vicinity of the first and second electrodes during breaking of the electrical circuit, whereby pressure in the vicinity is transiently reduced.

4. The circuit breaker of claim 1, wherein the shield comprises polymeric material.

5. The circuit breaker of claim 1, wherein the shield comprises polytetrafluoroethylene (PTFE).

6. The circuit breaker of claim 1, further comprising:
a gas evacuation provision for withdrawing gas from a vicinity of the first and second electrodes during breaking of the electrical circuit, whereby pressure in the vicinity is transiently reduced.

7. The circuit breaker of claim 6, wherein the gas evacuation provision for withdrawing gas comprises a piston/cylinder arrangement.

8. The circuit breaker of claim 7, wherein the piston is formed by one of the first and second electrodes.

9. The circuit breaker of claim 7, wherein the cylinder is formed by the shield.

10. The circuit breaker of claim 1, further comprising:
an enclosure containing the electrodes, the shield and a background gas.

11. The circuit breaker of claim 10, wherein a pressure of the background gas is sub-atmospheric.

12. The circuit breaker of claim 10, wherein the background gas comprises at least one of nitrogen, argon, carbon dioxide and air.

13. The circuit breaker of claim 10, wherein the background gas is at a pressure of less than about 60 kPa.

14. A circuit breaker, comprising:
a first electrode and a second electrode which are contactable with each other to complete a circuit connection;
a withdrawal mechanism for moving the first electrode away from the second electrode to break the circuit connection; and
a shield comprising a polymeric material arranged in proximity to the electrodes such as to be subject to ablation by the arc, wherein the shield defines a cavity between the electrodes within which arcing takes place, wherein ablation of the shield by the arc causes release of arc-extinguishing gas, and wherein a gas pressure below atmospheric pressure is provided in a vicinity of the electrodes during breaking of the circuit connection when the first electrode is moved away from the second electrode.

15. The system of claim 14, wherein the first electrode comprises a piston and the shield comprises a cylinder through which the piston moves.

16. The system of claim 15, further comprising:
an enclosure containing the electrodes, the shield and a background gas comprising at least one of nitrogen, argon, carbon dioxide and air, wherein the background gas is at a pressure of less than about 34 kPa.

17. The system of claim 16, wherein the shield comprises polytetrafluoroethylene.

18. A circuit breaker, comprising:
a first electrode disposed in selectable electrical contact with a second electrode, wherein an electrical connection is made when the first electrode is in contact with the second electrode;
a withdrawal means for moving the first electrode away from the second electrode to break the electrical connection;
a shield disposed in proximity to the second electrode and surrounding a portion of the first electrode, wherein the shield defines a cavity between the first electrode and the second electrode when the first electrode is moved away from the second electrode, whereby pressure in the cavity is transiently reduced, and wherein the shield comprises a polymeric material which releases of arc-extinguishing gas when ablated by an arc between the electrodes; and
an enclosure containing the electrodes, the shield and a background gas.

19. The circuit breaker of claim 18, wherein the background gas comprises at least one of nitrogen, argon, carbon dioxide and air, and wherein the background gas is at a pressure of less than about 34 kPa.

20. The circuit breaker of claim 18, wherein the shield comprises polytetrafluoroethylene.
